(19) United States
(12) Patent Application Publication
(10) Pub. No.: US 2005/0142024 A1
(43) Pub. Date: Jun. 30, 2005

(54) Method for producing three-dimensional sintered work pieces

(76) Inventor: Frank Herzog, Lichtenfels (DE)

Correspondence Address: LERNER AND GREENBERG, PA, P O BOX 2480, HOLLYWOOD, FL, 33022-2480, US

(21) Appl. No.: 10/836,506

(22) Filed: Apr. 30, 2004

(30) Foreign Application Priority Data
Oct. 30, 2001 (WO) PCT/DE01/04055

(51) Int. Cl. B29C 35/08; B29C 41/02; B22F 3/105

(52) U.S. Cl. 419/53; 264/401; 264/497; 264/460; 264/113; 264/482

(57) ABSTRACT

A method for producing three-dimensional sintered work pieces, in particular a stereo lithography method for application in a laser sinter machine, in which a sinter material, in particular liquid, pasty, powder or granular sinter material is applied in layers from a reservoir onto a backing and heated by partial irradiation of prescribed individual sections such that the components of the sinter material are combined to give the work piece by partial or complete fusion in regions dependent on the irradiation. The serially irradiated individual sections have a separation from each other, greater than or at least equal to average diameter of the individual sections.

### CROSS-REFERENCE TO RELATED APPLICATION

This application is a continuation, under 35 U.S.C. § 120, of copending international application No. PCT/DE01/04055, filed Oct. 30, 2001, which designated the United States.

### BACKGROUND OF THE INVENTION

### FIELD OF THE INVENTION

The invention relates to a method for producing three-dimensional sintered work pieces, in particular to a stereolithography method, which can be used in an automated sintering unit, in particular an automated laser sintering unit.

Published, European Patent Application EP 0 171 069 A discloses a method in which a layer of sintering material is applied to a substrate or to a layer which has already been consolidated and is consolidated by irradiation using a targeted laser beam. As a result, the three-dimensional sintered work piece is built up in layers. Express reference is made to the disclosure of EP 0 171 069 A, and the content of the disclosure of this European application is incorporated by reference herein and forms part of the subject matter of the present application.

Furthermore, it is known from German Patent DE 43 09 524 C2, corresponding to U.S. Pat. No. 5,932,059, to divide layers into individual sections and to successively consolidate the individual sections, for example squares. In this case, gaps are left between the individual regions or individual irradiation cells, ensuring that the work piece inner region cannot be distorted as a result of stresses.

The consolidation of individual, spaced-apart cells in the core region of the work piece while leaving clear gaps appears disadvantageous with regard to the stability of a work piece, in particular if the work piece is exposed to high mechanical loads, for example during use as an injection mold.

### SUMMARY OF THE INVENTION

It is accordingly an object of the invention to provide a method for producing three-dimensional sintered work pieces which overcomes the above-mentioned disadvantages of the prior art methods of this general type, in which distortions of the work pieces is reliably avoided even when relatively large work pieces are being produced.

With the foregoing and other objects in view there is provided, in accordance with the invention, a method for producing three-dimensional sintered work pieces. The method includes the steps of providing a substrate, applying a sintering material to the substrate in layers from a storage device, and heating the sintering material by regionally irradiating defined individual sections for at least partially melting constituents of the sintering material for joining the sintering material to one another in dependence on the individual sections being radiated to form a work piece. The individual sections are irradiated successively in terms of time and disposed at a distance from one another. The distance is greater than or at least equal to a mean diameter of the individual sections.

One of the core concepts of the invention is the successive irradiation of the individual sections, such that successively irradiated individual sections are at a distance from one another which is greater than or at least equal to the mean diameter of an individual section. In particular, the individual sections should be successively irradiated in a stochastic distribution and the distance between them should be such that the introduction of heat into the layer that occurs as a result of the thermal irradiation is substantially uniform. This avoids stresses, which in the prior art have in some cases even resulted in individual layers not being correctly joined to one another but rather breaking off or flaking away in layers, leading to destruction of the work piece.

In particular, the successive irradiation can be carried out in such a way that edges of adjacent individual sections overlap. Therefore, the irradiation goes beyond the defined surface region of the individual section and also encompasses the adjoining region, so that a grid structure, the density of which differs from the surface regions located within the grid structure since the sintering material in the region of the grid structures is irradiated repeatedly or with an increased introduction of energy, is formed between the individual sections.

However, in the context of the invention, the sintering-in of a grid structure can also be carried out without regional irradiation of individual sections. First, the sintering is carried out along the grid structure lines and then the regions located within the grid structure are irradiated individually or areally. This can be achieved by the laser beam actually covering only the individual regions within the grid structure. However, it is also within the scope of the invention for the entire area to be scanned in linear form and for the lines of the grid structure to be passed over once again or to cross one another.

Within the sections, irradiation is performed by irradiation lines located next to one another, but other types of irradiation are also possible. It is also possible to irradiate adjacent individual sections in such a way that the irradiation lines of adjacent individual sections are disposed at right angles to one another.

Moreover, it may be advantageous for the edges of the individual sections, after irradiation of the inner regions of the individual sections, additionally to be exposed to a peripheral irradiation.

Furthermore, it may be advantageous for the grid structure to be in an offset configuration within a work piece, i.e. for the grid lines of layers positioned on top of one another not to lie above one another, but rather to be disposed offset with respect to one another, so that the individual sections of the layers in the assembly lie above one another, as is the case with bricks of a brick wall laid in bond.

The individual sections of layers disposed above one another may be of different sizes, different shapes and/or may have a different orientation. It may be advantageous for a structure that differs with respect to the work piece inner region, in particular a grid structure, to be sintered into the region of the work piece surface.

Furthermore, it may be advantageous for the edge region of the work piece to be sintered with a higher density, and in particular the density in the edge region may approximately correspond to the density of the grid structure in the work piece core region. The higher density can be achieved by substantially complete melting of the sintering material in the edge region. The higher density can also be sintered into the region of inner surfaces at work pieces passages, screw threads which are to be machined in or the like, so that work piece passages and work piece surfaces can be re-machined, in particular by chip-forming or grinding machining.

The overlap between adjacent individual sections should be approximately 0.03-0.5 mm, depending on the work piece size, but may also be significantly above or below this range. The overlap may be greater in the edge region of the work piece than in the core region of the work piece.

In more extensively structured work piece regions, it is advantageous for longer time periods to be left between the laser irradiation of adjacent sintered sections than in the case of sintered regions that are of a flatter configuration.

Other features which are considered as characteristic for the invention are set forth in the appended claims.

Although the invention is illustrated and described herein as embodied in a method for producing three-dimensional sintered work pieces, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, plan view of a layer of a sintered work piece which has been taken by way of example and according to the invention;

FIG. 2 is a diagrammatic, enlarged plan view of a layer of the sintered work piece which has been taken by way of example;

FIG. 3 is a diagrammatic, plan view of a grid structure of the sintered work piece;

FIG. 4 is a diagrammatic, plan view of an alternative embodiment of a grid structure of the sintered work piece;

FIG. 5 is diagrammatic, sectional view through layers of individual sections disposed above one another; and

FIG. 6 is a diagrammatic, plan view of a layer of the work piece taken by way of example.

### DESCRIPTION OF THE PREFERRED EMBODIMENTS

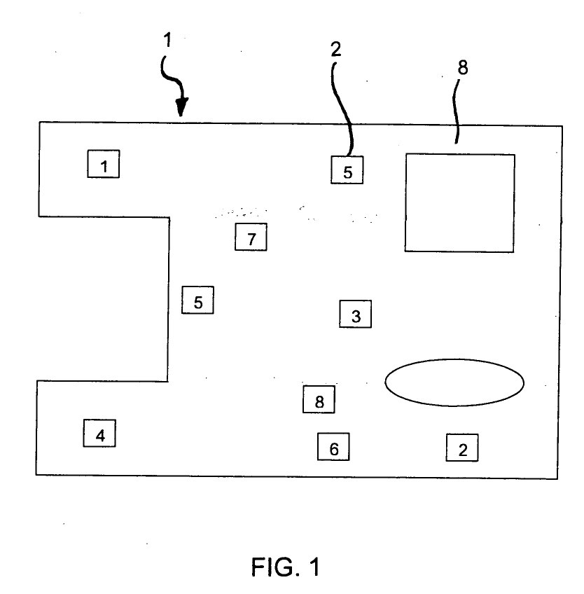

Referring now to the figures of the drawing in detail and first, particularly, to FIG. 1 thereof, there is shown a method according to the invention for producing three-dimensional sintered work pieces 1, which in particular is a stereolithography method for use in an automated laser sintering unit. First, a sintering material is applied to a substrate in layers 8 from a storage device. The sintering material may be liquid, pasty, pulverulent or granular. Then, the sintering material is heated by regional irradiation of defined individual sections 2, in such a manner that the constituents of the sintering material, with complete or at least partial melting, are joined to one another as a function of irradiation regions to form the work piece 1.

As can be seen from the plan view of the work piece 1 shown in FIG. 1, the individual sections 2 which are irradiated successively in terms of time are at a distance from one another that is greater than or at least equal to a mean diameter of the individual sections 2. The individual sections 2 are provided with numerals illustrating the order in which they are irradiated. The individual sections 2 are in this case irradiated successively in a stochastic distribution. As a result of the individual sections 2 being irradiated in the manner outlined, stresses that result from changes in the material are distributed uniformly over the work piece 1 and distortion of the work piece 1 is prevented. In particular, the individual sections 2 which are irradiated successively in terms of time are at a distance from one another that is such that the introduction of heat which occurs as a result of the irradiation takes place substantially uniformly into the layer 8, 8′ which is to be sintered.

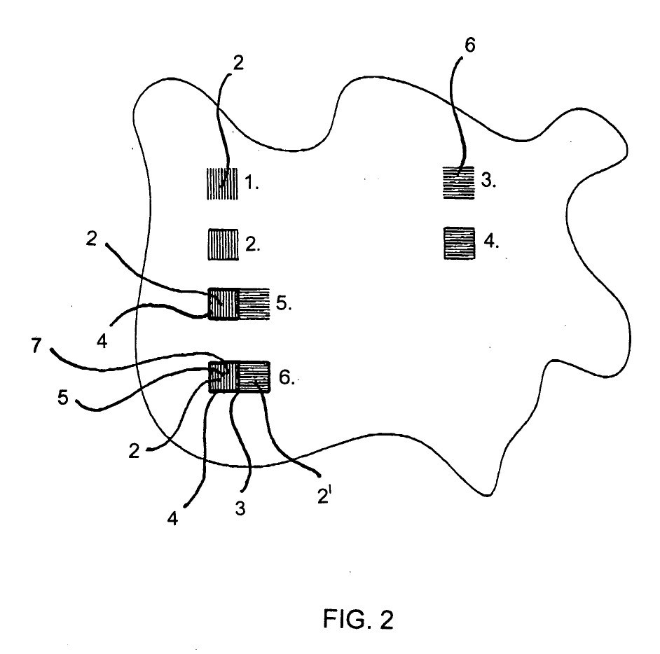

In the enlarged excerpt of the work piece 1 illustrated in FIG. 2, the order of the irradiated individual sections 2 is once again provided with corresponding numerals. As is shown in step 5 or step 6, edges of adjacent individual sections 2, 2′ overlap one another. This results in the formation of a grid structure 3 which has an increased density compared to the inner regions of the individual sections 2, 2′, since the edge regions 4 of the individual sections 2, 2′ are melted more than once, with an increased introduction of energy. The grid structure 3 with its increased density can absorb forces which occur when the finished work piece 1 is in use, with the required ductility of the work piece 1 being achieved as a result of the lower density of the individual sections 2, 2′. This makes it possible to produce the work piece 1 with a high hardness and tensile strength combined, at the same time, with a high ductility. It is then possible for the laser beam to pass around the edge regions 4 once again.

As an alternative to the above-described production of the grid structure 3, it is also possible for the grid structure 3, the density of which differs from surface regions 5 located within the grid structure 3, to be sintered into the layers of sintering material. The density of the grid structure 3 is in this case preferably higher than the density of the surface regions 5 located therein. To produce the grid structure 3, it is possible for the laser beam to be moved over the entire work piece 1 in a manner corresponding to the grid structure 3. It is then possible for the surface regions 5 located in between also to be melted, in particular in a stochastic distribution as outlined above. As a result, the surface regions 5 located in between also acquire the required strength and at the same time impart the required ductility to the work piece 1.

Within the individual sections 2, 2′, as shown in FIG. 2, irradiation in row or column form is carried out by irradiation lines 6 located next to one another. The adjacent individual sections 2, 2′ (in steps 5 and 6) have irradiation lines 6 located at right angles to one another, with the result that overall a uniform texture is formed over the entire work piece 1 if all the individual sections 2, 2′ are irradiated with irradiation lines 6 which are offset with respect to one another, in particular are located at right angles to one another. Moreover, this configuration of the irradiation lines further reduces stresses in the work piece 1.

As an alternative irradiation method, it is possible for the individual sections 2, 2′ to be irradiated in punctiform fashion in their inner region 7, so that both the individual sections 2, 2′ and the work piece 1 as a whole are isotropic in structure. The edges or edge regions 4 of the individual sections 2, 2′ in accordance with FIG. 2 are additionally exposed to a peripheral irradiation following the irradiation of the section inner regions 7, so that the desired grid structure 3 is clearly formed. This increased application of laser sintering energy leads to additional strengthening, which is of benefit to the ability of components of this type to mechanically withstand distortion and the like.

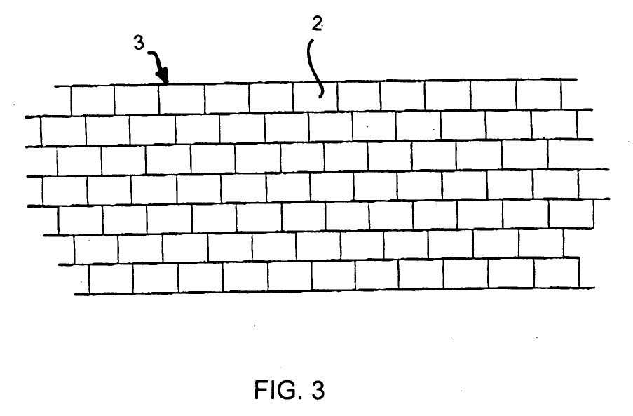

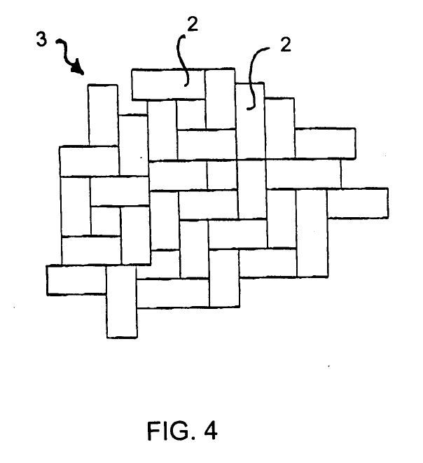

In accordance with FIG. 3, the grid structure 3 is in an offset configuration within the work piece 1. However, it is also possible for the grid structure 3 to be in an offset configuration in both directions (see FIG. 4), so that the stresses that may result from the grid structure 3 are compensated for still further. In this case, the individual sections 2 are also of different sizes, in order, for example, to satisfy different demands in the edge region or inner region of the sintered work piece 1.

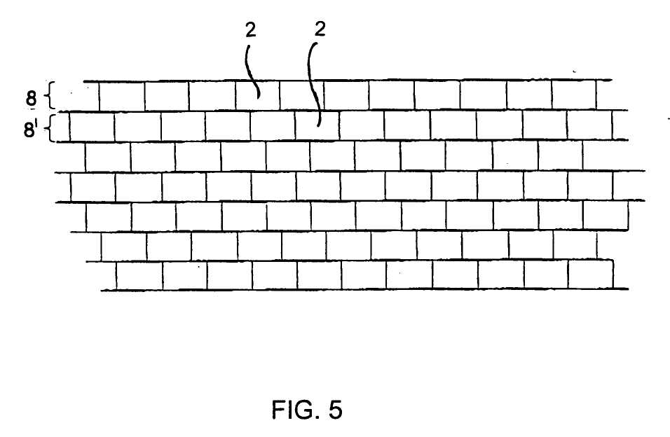

It is also possible for the individual sections 2 of layers 8, 8′ disposed above one another to be of different sizes and/or of different shapes and/or to have different orientations with respect to a longitudinal axis. The individual sections 2, 2′ of layers 8, 8′ disposed above one another are disposed offset with respect to one another in accordance with FIG. 5. The result is a high-strength, distortion-free structure.

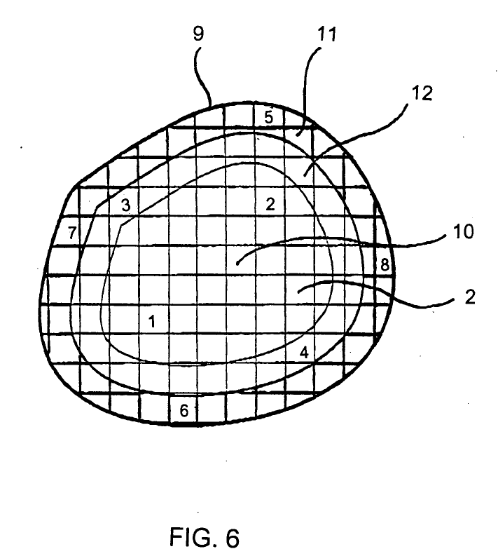

FIG. 6 shows a different configuration of the grid structure 3 in the region of a work piece surface 9 compared to a work piece inner region 10. The mean density in an edge region 11 approximately corresponds to the density of the grid structure in the work piece inner region 10. An intermediate region 12, which is located between the edge region and the inner region, has a mean density that is between the mean density of the edge region and of the inner region. Moreover, the mean density of the overall edge region 11 is higher than in the work piece inner region 10. The higher density in the edge region 11 leads to simpler re-machining of the outer surfaces, for example, by chip-forming or grinding machining. The higher density of the grid structure 3 in the edge region 11 also produces an increased strength of the highly loaded work piece surface and a ductility in the core region of the work piece 1, so that the work piece 1 is protected, for example, from brittle fracture. This can be achieved using a laser focal spot of higher energy density. The higher density in the edge region 11 can be achieved by substantially complete melting of the sintering material. The higher density can also be sintered into the region of inner surfaces at work piece passages, screw threads or other formations, which can accordingly be re-machined without difficulty after sintering. Moreover, this also results in that the inner surfaces, which are generally exposed to high levels of load, also have the required hardness. In this figure too, some individual sections 2 are provided, by way of example, with numerals that illustrate the order in which they are irradiated.

The overlap between adjacent individual sections 2, 2′ is approximately 0.03-0.5 mm. The overlap is preferably greatest in the edge region 11 of the work piece 1 and decreases across the intermediate region 12 to the inner region 10. Accordingly, the mean density is also highest in the edge region 11. The edge region 11 of the work piece 1 may also be melted completely, with the result that just in the edge region 11 the grid structure 3 is no longer present. For this purpose, a laser focal spot of higher energy density is used in the edge region.

To ensure a uniform introduction of energy, there are longer time periods between the irradiation of adjacent sintered sections in more extensively structured work piece regions than in sintered regions that are of a flatter configuration. The sintering materials used may be both metallic powders, pastes, liquids or granular material or plastics sintering material.

1. A method for producing three-dimensional sintered work pieces, which comprises the step of:
providing a substrate;
applying a sintering material to the substrate in layers from a storage device; and
heating the sintering material by regionally irradiating defined individual sections for at least partially melting constituents of the sintering material for joining the sintering material to one another in dependence on the individual sections being radiated to form a work piece, the individual sections being irradiated successively in terms of time being disposed at a distance from one another, the distance being greater than or at least equal to a mean diameter of the individual sections.

2. The method according to claim 1, which further comprises successively irradiating the individual sections in a stochastic distribution.

3. The method according to claim 1, which further comprises irradiating successively the individual sections such that an introduction of heat which occurs as a result of irradiation takes place substantially uniformly into a layer which is to be sintered.

4. The method according to claim 1, which further comprises forming the individual sections so that edges of adjacent ones of the individual sections overlap.

5. The method according to claim 1, which comprises performing the irradiating within the individual sections by irradiation lines located next to one another (row or column irradiation).

6. The method according to claim 1, which further comprises subjecting the individual sections to punctiform irradiation in an inner region of the individual sections.

7. The method according to claim 1, which further comprises exposing edges of the individual sections, after irradiation of section inner regions of the individual sections, to a peripheral irradiation.

8. The method according to claim 1, which further comprises forming the individual sections in a grid structure in an offset configuration within the work piece.

9. The method according to claim 1, which further comprises forming the individual sections to have layers of different sizes disposed above one another.

10. The method according to claim 1, which further comprises forming the individual sections to have layers of different shapes disposed one above another.

11. The method according to claim 1, which further comprises forming the individual sections to have layers of different orientations with respect to a longitudinal axis layer and disposed one above another.

12. The method according to claim 1, which further comprises forming the layers to be disposed one above another and offset one above another.

13. The method according to claim 1, which further comprises sintering a structure which is different with respect to a work piece inner region, into a region of work piece surfaces.

14. The method according to claim 8, which further comprises forming a mean density in an edge region to approximately correspond to a density of the grid structure.

15. The method according to claim 1, which further comprises forming a density in an edge region of the work piece to be higher than in a work piece inner region.

16. The method according to claim 15, which further comprises achieving the higher density in the edge region by substantially complete melting of the sintering material in the edge region.

17. The method according to claim 15, which further comprises sintering a higher density into a region of inner surfaces where work piece passages and areas for screw threads are formed.

18. The method according to claim 4, which further comprises forming the overlap between adjacent ones of the individual sections to be approximately 0.03-0.5 mm.

19. The method according to claim 4, which further comprises forming the overlap to be greater in an edge region of the work piece than in an inner region of the work piece.

20. The method according to claim 1, which further comprises substantially completely melting the sintering material in an edge region of the work piece.

21. The method according to claim 20, which further comprises using a laser focal spot of higher energy density in the edge region.

22. The method according to claim 1, which further comprises allowing longer time periods between irradiating adjacent ones of the sintered sections in more extensively structured work piece regions than in sintered regions which are of a flatter configuration.

23. The method according to claim 1, which further comprises using a metallic sintering material as the sintering material.

24. The method according to claim 1, which further comprises using a plastic sintering material as the sintering material.

25. The method according to claim 1, which further comprises selecting the sintering material from the group consisting of a liquid sintering material, a pasty sintering material, a pulverulent sintering material and a granular sintering material.

26. The method according to claim 1, which further comprises sintering a grid structure which is different with respect to a work piece inner region, into a region of work piece surfaces.

27. The method according to claim 1, which further comprises performing the method as a stereolithography process in an automated laser sintering unit.

28. A method for producing three-dimensional sintered work pieces, which comprises the step of:
providing a substrate;
applying a sintering material to the substrate in layers from a storage device;
heating the sintering material by regionally irradiating defined individual sections for at least partially melting constituents of the sintering material for joining the sintering material to one another in dependence on the individual sections being radiated to form a work piece, the heating resulting in a sintering of a grid structure into the layers, a density of the grid structure differing from surface regions located within the grid structure.

29. The method according to claim 28, which further comprises forming the grid structure with a higher density than the surface regions located within the grid structure.

30. The method according to claim 28, which further comprises forming the grid structure by an overlap between adjacent ones of the individual sections as a result of multiple irradiation.
